(19) United States
(12) Patent Application Publication
(10) Pub. No.: US 2005/0274098 A1
(43) Pub. Date: Dec. 15, 2005

(54) Lawnmower override assembly apparatus and method

(76) Inventors: Steve J. Weber, Germantown, WI (US); Daniel W. Schaefer, Port Washington, WI (US)

Correspondence Address: MICHAEL BEST & FRIEDRICH, LLP, 100 E WISCONSIN AVENUE, MILWAUKEE, WI, 53202, US

(21) Appl. No.: 10/858,569

(22) Filed: Jun. 1, 2004

(51) Int. Cl. A01D 75/28

(52) U.S. Cl. 56/10.2 R

(57) ABSTRACT

Override assembly apparatus and method for use with a lawnmower including a control circuit coupled to a first housing. The control circuit can prevent the lawnmower from cutting while the lawnmower is moving in a reverse direction. The override assembly can include a second housing separate from the first housing, a user-manipulatable control, and a terminal block. The override assembly can include an override circuit that can operate in a first state in which the control circuit is enabled and a second state in which the control circuit is disabled in response to the user-manipulatable control.

### BACKGROUND OF THE INVENTION

Riding lawnmowers often include a control circuit that controls the cutting operation of the lawnmower based upon the direction that the lawnmower is moving. For example, conventional control circuits disable the cutting apparatus (e.g., one or more cutting blades) when the lawnmower is moving in a reverse direction. However, some users of the lawnmower may want to enable the cutting apparatus when the lawnmower is moving in both the forward and reverse directions. Accordingly, an override option is often desired.

### SUMMARY OF THE INVENTION

Conventionally, override circuits have been combined with other lawnmower control circuits, resulting in costly and complex circuit assemblies. Integrating the override and control circuits can result in both circuits being burdensome to maintain and service. In light of these problems, a need exists for a modular override assembly that is provided separately from the other lawnmower control circuits in order to simplify the override circuit, in order to allow a manufacturer to easily install the override circuit in a lawnmower, and in order to allow a user to easily access the override circuit for any maintenance that may be required.

In one embodiment, the invention provides an override assembly for use with a lawnmower having a control circuit to control operation of the lawnmower. The control circuit can be included in a first housing. The override assembly can include a second housing separate from the first housing. A user-manipulatable control can be coupled to the second housing. A terminal block can be coupled to the second housing and the user-manipulatable control. An override circuit can be coupled to the second housing, the user-manipulatable control, and the terminal block. The terminal block can be adapted to be coupled to the control circuit when the override assembly is coupled to the lawnmower. The override circuit can operate in a first state in which the control circuit is enabled and in a second state in which the control circuit is disabled in response to the user-manipulatable control.

In some embodiments, the invention provides a method of assembling a lawnmower. The method can include coupling a first housing to a first portion of the lawnmower. The first housing can include a control circuit which can prevent the lawnmower from cutting while the lawnmower is moving in a reverse direction. The method can also include coupling a second housing to a second portion of the lawnmower. The second housing can be separate from the first housing. The second housing can include an override circuit and a user-manipulatable control. The override circuit can be capable of disabling the control circuit in response to the user-manipulatable control.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

The invention is further described with reference to the accompanying drawings, which show some embodiments of the invention. However, it should be noted that the invention as disclosed in the accompanying drawings is illustrated by way of example only. The various elements and combinations of elements described below and illustrated in the drawings can be arranged and organized differently to result in embodiments which are still within the spirit and scope of the invention.

In the drawings, wherein like reference numerals indicate like parts:

FIG. 1 is a perspective view of a lawnmower.

FIG. 2 is a partial perspective view of a lawnmower, such as the lawnmower of FIG. 1.

FIG. 3 is a front perspective view of an override assembly for a lawnmower.

FIG. 4 is a rear perspective view of an override assembly, such as the override assembly of FIG. 3, for a lawnmower.

FIG. 5 is an exploded view of an override assembly, such as the override assembly of FIG. 3, for a lawnmower.

FIG. 6 is a schematic diagram of an override circuit, such as the override circuit included in the assembly of FIG. 3, for a lawnmower.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

In addition, it should be understood that embodiments of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software. As such, it should be noted that a plurality of hardware and software based devices, as well as a plurality of different structural components may be utilized to implement the invention. Furthermore, and as described in subsequent paragraphs, the specific mechanical configurations illustrated in the drawings are intended to exemplify embodiments of the invention and that other alternative mechanical configurations are possible.

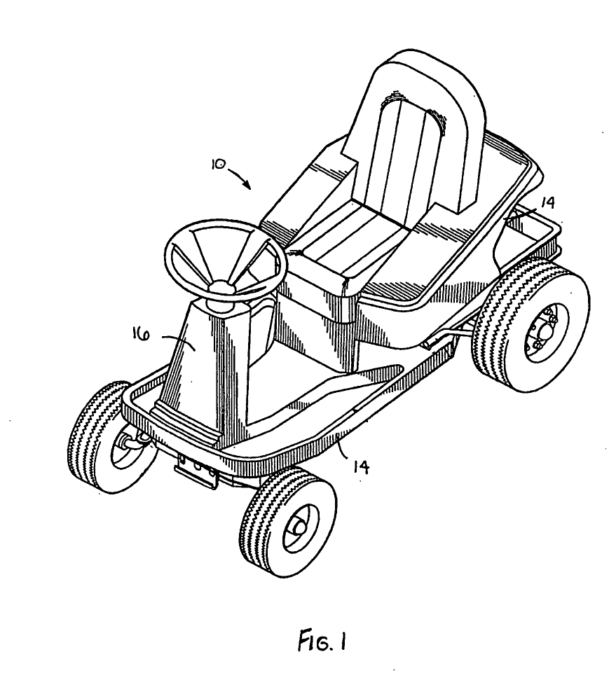

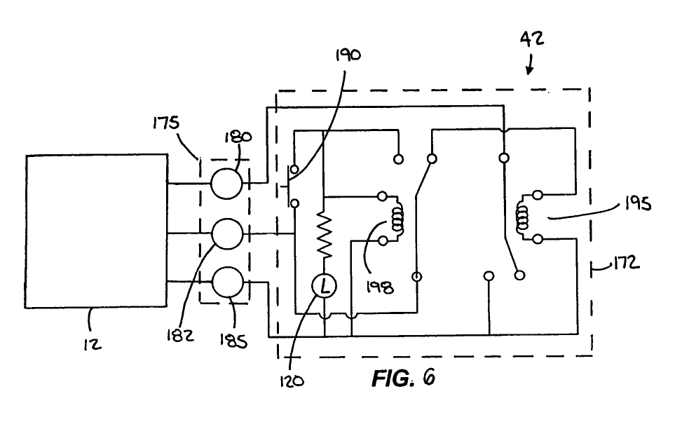

FIG. 1 illustrates a lawnmower 10 according to one embodiment of the invention. The lawnmower 10 illustrated in FIG. 1 is a riding lawnmower capable of moving in a forward direction and a reverse direction. The lawnmower 10 can also include a power take off (not shown), a cutting apparatus (not shown), and a control circuit 12 (as shown schematically in FIG. 6) that controls the power take off and/or the cutting apparatus. The cutting apparatus can include, for example, one or more cutting blades. In some embodiments, the control circuit 12 can disable the cutting apparatus when the lawnmower 10 is moving in the reverse direction. It should be understood by one of ordinary skill in the art that the phrase “moving in the reverse direction” as used herein and in the appended claims refers to either actual movement of the lawnmower 10 or the appropriate gearing being selected by a user before the lawnmower 10 actually begins to move.

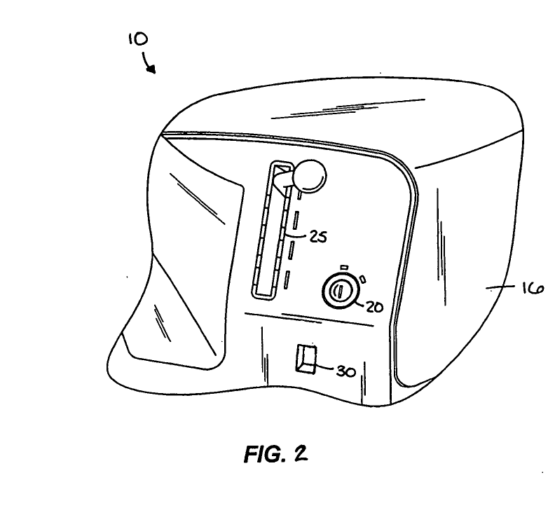

As shown in FIGS. 1 and 2, the lawn rower 10 can include a housing 14 that can substantially cover the cutting apparatus and the control circuit 12. The housing 14 can include a console 16 with an ignition switch 20 and/or a gear shift 25. The gear shift 25 can allow a user to select the gearing of the lawnmower 10 (e.g., forward, reverse, and idle or neutral). The console 16 can also include additional switches, controls, and/or indicators, such as, for example, a throttle switch (not shown).

The console 16, as shown in FIG. 2, can define a receiving port 30 that can receive an additional or supplemental control circuit assembly and can connect the assembly to the control circuit 12. In some embodiments, the receiving port 30 can receive an override circuit assembly 40 (as shown in FIGS. 3-6). When activated by a user, the override circuit assembly 40 can override the control circuit 12 to permit cutting by the lawn rower 10 when the lawnmower 10 is moving in the reverse direction.

FIGS. 3-5 illustrate the override assembly 40 according to one embodiment of the invention. The override assembly 40 can include an override circuit 42 (as shown schematically in FIG. 6) that can override one or more functions of the control circuit 12 of a lawnmower 10. The override circuit 42 can operate according to at least a first state and a second state. For example, the first state can enable the override circuit 42 and permit cutting when the lawnmower is moving in the reverse direction, and the second state can disable the override circuit 42 and prohibit cutting when the lawnmower is moving in the reverse direction.

As shown in FIGS. 3-5, the override assembly 40 can be a modular unit configured to be inserted into the receiving port 30 (as shown in FIG. 2) by a manufacturer during assembly or by a user during maintenance. In some embodiments, the override assembly 40 can be installed in the receiving port 30 without using tools. The override assembly 40 can include a housing 45 having a plurality of sides, such as a first side 50, a second side 55, a third side 60, a fourth side 65, a top side 70, and a bottom side 75. The first side 50, the second side 55, the third side 60 and the fourth side 65 form a first perimeter 80. The top side 70 can include a top surface 85 having a second perimeter 90 that can be substantially greater than the first perimeter 80 (defined by the first side 50, the second side 55, the third side 60, and the fourth side 65). In some embodiments, the first perimeter 80 of the override assembly 40 can be substantially less than the perimeter of the receiving port 30, and the top side 70 can be configured to substantially close the receiving port 30 when the override assembly 40 is inserted into the receiving port 30.

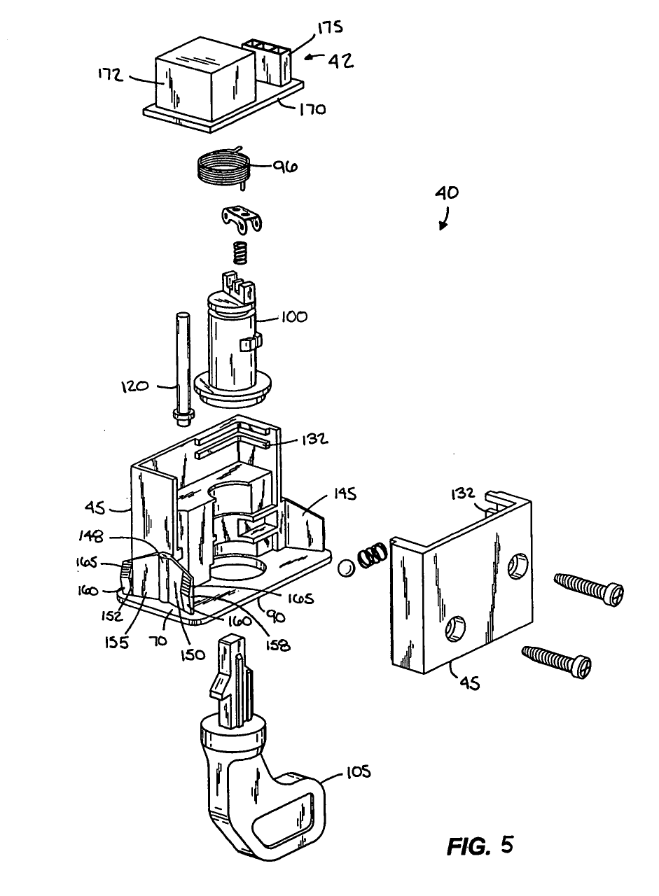

The top side 70 of the override assembly 40 can include a user-manipulatable control 95. The user-manipulatable control 95 can allow a user to activate and deactivate the override circuit 42 which, in turn, allows a user to enable or disable the cutting operation of the lawnmower 10 when moving in the reverse direction. In some embodiments, the user-manipulatable control 95 can include a key cylinder 100 that is adapted to receive a key 105 (which can be either removable or non-removable from the key cylinder 100). The user-manipulatable control 95 can include a bias member 96 (as shown in FIG. 5) for biasing the user-manipulatable control 95 into a particular position. In other embodiments, the user-manipulatable control 95 can include any other suitable control, such as, for example, a switch, a push button, a key pad, etc.

The top side 70 of the override assembly 40 can include an indicator 120. The indicator 120 can signal to the user the current state of the override circuit 42. In some embodiments, the indicator 120 can include a light-emitting diode (LED). For example, when the override circuit 42 is activated via the user-manipulatable control 95, the indicator 120 can be illuminated. In other embodiments, the indicator 120 can be illuminated when the control circuit 12 and the override circuit 42 prohibit the lawnmower 10 from cutting when moving in a reverse direction (e.g., the indicator 120 can be illuminated when the override circuit 42 is not activated).

In other embodiments, the override assembly 40 can include other suitable user-manipulatable controls 95 and/or indicators 120, such as, for example, an alarm, a buzzer, a mechanical switch, etc. For example, a mechanical switch can include a first physical position that provides for and indicates that the override circuit 42 is in the first state and a second physical position that provides for and indicates that the override circuit 42 is in the second state.

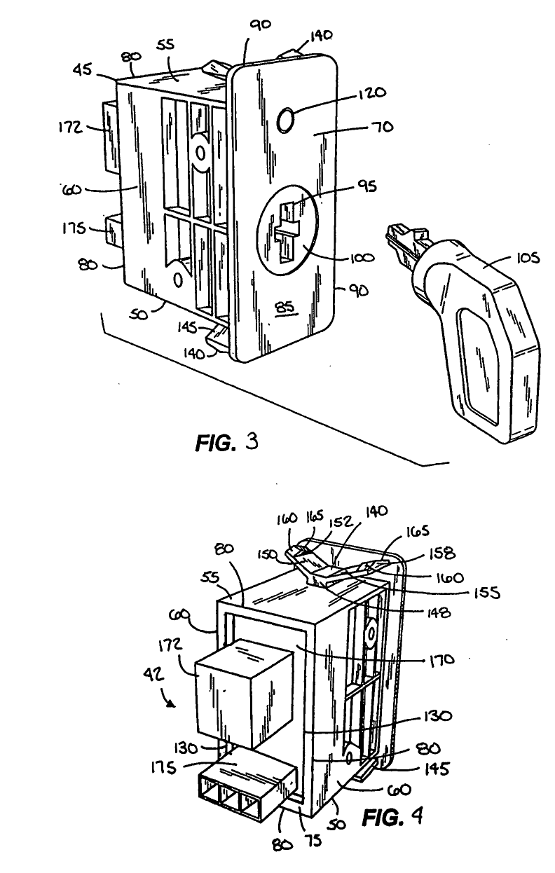

As shown in FIG. 4, the bottom side 75 of the housing 45 can define an aperture 130. The aperture 130 can allow the override circuit 42 (that can be substantially enclosed or positioned within the housing 45) to be electrically connected to the control circuit 12 (that can be substantially enclosed or positioned within a separate lawnmower housing 14).

The housing 45 can include one or more protrusions 132 positioned within the interior surfaces of the first side 50, the second side 55, the third side 60, and the fourth side 65. The protrusions 132 can aid with the positioning of the override circuit 42 within the housing 45.

The override assembly 40 can include one or more locking members 140 to secure the override assembly 40 within the receiving port 30. In some embodiments, the override assembly 40 can include a first resilient tab 145 and a second resilient tab 148 as first and second locking members 140, respectively. In some embodiments, each resilient tab 145 and 148 can include a first wing 150 having a first raised portion 152 and a second wing 155 having a second raised portion 158. The raised portions 152 and 158 can each include a ramped surface 160 and a grooved surface 165. During insertion into the receiving port 30, the ramped surface 160 can help guide the locking member 140 past a protrusion (not shown) within the receiving port 30, and the grooved surface 165 can help prevent the override assembly 40 from falling out of the receiving port 30. As shown in FIGS. 3-5, the first locking member 145 can be positioned on the first side 50 of the housing 45, and the second locking member 148 can be positioned on the second side 55 of the housing 45. In other embodiments, the override assembly 40 can include more or fewer locking members 140 than those shown and described and can be positioned at different locations on the housing 45 than those shown and described.

The override circuit 42 can include a printed circuit board 170, one or more circuit elements 172, and a terminal block 175. As shown in FIG. 5, the circuit elements 172 of the override circuit 42 (as shown schematically in FIG. 6) can be positioned on and coupled to the printed circuit board 170. In one embodiment, the printed circuit board 170 can at least partially rest on the protrusions 132 of the housing 45. In some embodiments, the printed circuit board 170 can couple the circuit elements 172 of the override circuit 42 to the terminal block 175. The terminal block 175 can electrically connect the circuit elements 172 of the override circuit 42 to the control circuit 12 when the override assembly 40 is inserted into the receiving port 30 of the lawnmower 10.

FIG. 6 schematically illustrates the terminal block 175 and the circuit elements 172 of the override circuit 42, which are coupled to a separate housing 45, but are electrically connected to the control circuit 12 of the lawnmower 10. As shown in FIG. 6, the terminal block 175 can include a first terminal 180, a second terminal 182, and a third terminal 185. In some embodiments, the first terminal 180 can be coupled to the ground of the control circuit 12, the second terminal 182 can be coupled to a clutch (not shown), and the third terminal 185 can be coupled to a foot pedal or accelerator (not shown).

As shown in FIG. 6, the circuit elements 172 of the override circuit 42 can include an override switch 190 having an open position and a closed position. In some embodiments, the override switch 190 can be biased in the open position by the bias member 96 and can be activated into the closed position by the user-manipulatable control 95.

The circuit elements 172 can include a first relay 195 and a second relay 198. The first relay 196 can be a run circuit relay and can connect the second terminal 182 to the third terminal 185 when the override circuit 42 is not activated (e.g., when the switch 190 is in the open position). The first relay 196 can allow the control circuit 12 to disable the cutting operation when the lawnmower 10 is moving in the reverse direction.

The second relay 198 can be an override relay and can connect the second terminal 182 and the third terminal 185 to the first terminal 180 (e.g., ground) when the override circuit 42 is activated (e.g., when the switch 190 is in the closed position). The second relay 198 can override the control circuit 12 to enable the cutting operation when the lawnmower 10 is moving in the reverse direction. In some embodiments, the second relay 198 can also activate the indicator 120 when the switch 190 is in the closed position.

In some embodiments, the circuit elements 172, such as, for example, the switch 190, the first relay 196 and the second relay 198, can be included in a single integrated circuit (IC). In other embodiments, the override circuit 42 can be implemented using an IC with digital logic components.

According to one method of the invention, a lawnmower can be assembled by coupling a first housing 14 to a first portion of the lawnmower 10. The first housing 14 can include the control circuit 12 that partially or completely controls the general operation of the lawnmower 10. The control circuit 12 can normally prevent the lawnmower 10 from cutting while the lawnmower 10 is moving in a reverse direction. The method can also include coupling a second housing 45 to a second portion of the lawnmower 10, such as the receiving port 30. The second housing 45 can be separate from the first housing 14 that includes the control circuit 12. The second housing 45 can include an override circuit 42 and a user-manipulatable control 95. The override circuit 42 can be capable of disabling the control circuit 12 in response to the user-manipulatable control 95. In some embodiments, the method described above can be used by a manufacturer to assemble the lawnmower 10. In other embodiments, appropriate portions of the method described above can be used to replace the override circuit assembly 40 in a lawnmower 10.

According to another method of the invention, the lawnmower 10 can include a power take off (not shown) coupled to a cutting apparatus (not shown) and the power take off can be operated when the lawnmower 10 is moving or geared to move in a forward direction. The method can include preventing the power take off from operating when the lawnmower 10 is moving in a reverse direction using the control circuit 12. The control circuit 12 can be included in a first housing 14 coupled to the lawnmower 10. The method can include disabling the control circuit 12 by activating the override circuit 42 when the user-manipulatable control 95 is manipulated in order to allow the power take off to operate when the lawnmower 10 is moving in the reverse direction. The override circuit 46 and the user-manipulatable control 95 can be included in a second housing 45 coupled to the lawnmower 10 separately from the first housing 14 that includes the control circuit 12.

In some embodiments, the override circuit 42 can return to the first state in which the control circuit 12 is enabled when the lawnmower 10 is shut down. In other embodiments, the override circuit 46 can return to the first state in which the control circuit 12 is enabled when the lawnmower 10 begins moving or geared to move in a forward direction after moving in a reverse direction. In still other embodiments, the override circuit 46 can return to the first state in which the control circuit 12 is enabled when the power take off coupled to the cutting blade is turned off.

In general, all the embodiments described above and illustrated in the figures are presented by way of example only and are not intended as a limitation upon the concepts and principles of the invention. As such, it will be appreciated by one having ordinary skill in the art that various changes in the elements and their configuration and arrangement are possible without departing from the spirit and scope of the invention as set forth in the appended claims.

1. An override assembly for use with a lawnmower, the lawnmower including a control circuit coupled to a first housing, the control circuit preventing the lawnmower from cutting while the lawnmower is moving in a reverse direction, the override assembly comprising:
a second housing separate from the first housing;
a user-manipulatable control coupled to the second housing;
a terminal block coupled to the second housing and the user-manipulatable control, the terminal block adapted to be coupled to the control circuit when the override assembly is coupled to the lawnmower; and
an override circuit coupled to the second housing, the user-manipulatable control, and the terminal block, the override circuit operating in a first state in which the control circuit is enabled, the override circuit operating in a second state in which the control circuit is disabled in response to the user-manipulatable control.

2. The override assembly of claim 1 wherein the user-manipulatable control includes a key cylinder and a key.

3. The override assembly of claim 1 wherein the user-manipulatable control includes a switch.

4. The override assembly of claim 1 wherein the second housing includes an indicator in order to indicate to a user whether the override circuit is in the first state or the second state.

5. The override assembly of claim 4 wherein the indicator is a light-emitting diode.

6. The override assembly of claim 1 wherein the override assembly is a modular unit that is installed in the lawnmower separately from the first housing.

7. The override assembly of claim 1 wherein the override circuit includes a switch and at least one relay.

8. The override assembly of claim 1 wherein the override circuit includes a switch and an integrated circuit.

9. The override assembly of claim 1 wherein the terminal block is adapted to be coupled to a clutch and an accelerator of the lawnmower.

10. The override assembly of claim 1 wherein the override circuit returns to the first state in which the control circuit is enabled when the lawnmower is shut down.

11. The override assembly of claim 1 wherein the override circuit returns to the first state in which the control circuit is enabled when the lawnmower begins moving in a forward direction after moving in a reverse direction.

12. The override assembly of claim 1 wherein the override circuit returns to the first state in which the control circuit is enabled when a power take off coupled to a mowing blade is turned off.

13. The override assembly of claim 1 wherein the second housing includes at least one angled tab adapted to be secured within an aperture in the lawnmower in order to be secured to the lawnmower without additional fasteners.

14. A lawnmower comprising:
a control circuit coupled to a first housing, the control circuit preventing the lawnmower from cutting while the lawnmower is moving in a reverse direction; and
an override assembly including
a second housing separate from the first housing,
a user-manipulatable control coupled to the second housing,
a terminal block coupled to the user-manipulatable control, the terminal block in communication with the control circuit, and
an override circuit coupled to the user-manipulatable control and the terminal block, the override circuit operating in a first state in which the control circuit is enabled, the override circuit operating in a second state in which the control circuit is disabled in response to the user-manipulatable control.

15. The lawnmower of claim 14 wherein the user-manipulatable control includes a key cylinder and a key.

16. The lawnmower of claim 14 wherein the user-manipulatable control includes a switch.

17. The lawnmower of claim 14 wherein the second housing includes an indicator in order to indicate to a user whether the override circuit is in the first state or the second state.

18. The lawnmower of claim 17 wherein the indicator is a light-emitting diode.

19. The lawnmower of claim 14 wherein the override assembly is a modular unit that is installed in the lawnmower separately from the first housing.

20. The lawnmower of claim 14 wherein the override circuit includes a switch and at least one relay.

21. The lawnmower of claim 14 wherein the override circuit includes a switch and an integrated circuit.

22. The lawnmower of claim 14 wherein the terminal block is adapted to be coupled to a clutch and an accelerator of the lawnmower.

23. The lawnmower of claim 14 wherein the override circuit returns to the first state in which the control circuit is enabled when the lawnmower is shut down.

24. The lawnmower of claim 14 wherein the override circuit returns to the first state in which the control circuit is enabled when the lawnmower begins moving in a forward direction after moving in a reverse direction.

25. The lawnmower of claim 14 wherein the second housing includes at least one angled tab adapted to be secured within an aperture in the lawnmower in order to be secured to the lawnmower without additional fasteners.

26. A method of assembling a lawnmower, the method comprising:
coupling a first housing to a first portion of the lawnmower, the first housing including a control circuit, the control circuit preventing the lawnmower from cutting while the lawnmower is moving in a reverse direction; and
coupling a second housing to a second portion of the lawnmower, the second housing being separate from the first housing, the second housing including an override circuit and a user-manipulatable control, the override circuit capable of disabling the control circuit in response to the user-manipulatable control.

27. The method of claim 26 and further comprising coupling a second housing including a key cylinder and a removable key to the second portion of the lawnmower.

28. The method of claim 26 and further comprising coupling a second housing including a non-removable switch to the second portion of the lawnmower.

29. The method of claim 26 and further comprising coupling a second housing including an indicator to the second portion of the lawnmower, the indicator adapted to indicate a state of the override circuit to a user.

30. The method of claim 26 wherein the second housing is a modular unit, and further comprising coupling the modular unit to the second portion of the lawnmower.

31. The method of claim 26 wherein the second housing includes a terminal block coupled to the override circuit and the user-manipulatable control, and further comprising coupling the terminal block to a clutch and an accelerator of the lawn rower.

32. The method of claim 26 wherein the second housing includes at least one angled tab, and further comprising securing the second housing within an aperture in the lawnmower using the at least one angled tab without using additional fasteners.

33. A method of controlling a lawnmower, the lawnmower including a power take off coupled to a cutting apparatus, the method comprising:
operating the power take off when the lawnmower is moving in a forward direction;
preventing the power take off from operating when the lawnmower is moving in a reverse direction using a control circuit, the control circuit included in a first housing coupled to the lawnmower; and
disabling the control circuit by activating an override circuit when a user control is manipulated in order to allow the power take off to operate when the lawnmower is moving in the reverse direction, the override circuit and the user control included in a second housing coupled to the lawnmower separately from the first housing.

34. The method of claim 33 wherein the user control includes a key cylinder and a key, and further comprising activating and deactivating the override circuit when the key is manipulated by a user.

35. The method of claim 33 wherein the user control includes a switch, and further comprising activating and deactivating the override circuit when the switch is moved by a user.

36. The method of claim 33 and further comprising indicating to a user whether the override circuit is activated or deactivated.

37. The method of claim 33 and further comprising deactivating the override circuit when the lawnmower is shut down.

38. The method of claim 33 and further comprising deactivating the override circuit when the lawnmower begins moving in a forward direction after moving in a reverse direction.
